(19) United States
(12) Patent Application Publication
(10) Pub. No.: US 2009/0242628 A1
(43) Pub. Date: Oct. 1, 2009

(54) Driver's license and state issued ID card used to access store charge accounts and other business accounts

(76) Inventor: William T. Morrison, Jacksonville, FL (US)

Correspondence Address: William T. Morrison, Jr., 4917 Top Royal Lane, Jacksonville, FL, 32277, US

(21) Appl. No.: 12/381,112

(22) Filed: Mar. 6, 2009

Related U.S. Application Data
(60) Provisional application No. 61/068,949, filed on Mar. 11, 2008.

(51) Int. Cl. G06F 17/00; G06K 5/00

(52) U.S. Cl. 235/380

(57) ABSTRACT

A system and methodology of accessing a person's charge account record at a store or person's account record at other businesses using the person's driver's license or state issued ID card in addition to the access card that may have been issued by the store or the business. The unique number on the driver's license or state issued ID card captured by swiping or scanning the driver's license or state issued ID card or possibly manually entering the number would be used to retrieve the customer's record for appropriate action—charge for goods or services purchased in the case of stores or retrieving and updating records for other business customers. The driver's license and state issued ID card gives the employee of the store or business the opportunity to validate the information on the store charge account or business record with the personal human readable information on the driver's license and state issued ID card. This feature also offers more security to the customers against identity fraud.

### CROSS-REFERENCE TO RELATED APPLICATION

This application is entitled to the benefit of, and claims priority to provisional U.S. Patent Application Ser. No. 61/068,949 filed Mar. 11, 2008, and entitled “DRIVER'S LICENSE AND STATE ISSUED ID CARD USED TO ACCESS STORE CHARGE ACCOUNTS AND OTHER BUSINESS ACCOUNTS,” the entirety of which is incorporated herein by reference.

### FIELD OF THE INVENTION

The present invention relates to a system and a methodology for customers to access their records maintained by businesses such as but not limited to retail stores, service companies, doctors' offices and hospitals.

### BACKGROUND OF THE INVENTION

Many businesses are issuing their own cards to access accounts within their business. Company charge cards are probably the best known. More recently reward cards, VIP cards, frequent shopper/user cards and discount cards have created a significant increase in the number of cards customers are expected to carry. It is not uncommon for customers to carry a separate wallet or container just for their various store cards.

Many businesses also ask for a picture ID when a customer is using one of their store cards especially if the store card is being used to purchase goods or services. In these situations the customer usually swipes their store card through a card reader and then hands the sales clerk or cashier their driver's license for ID verification.

The most common picture ID used by businesses to identify their customers is the driver's license or state issued identification card. These forms of IDs contain a picture, physical information, date of birth, date issued and signature of the bearer along with other data. Most state issued driver's licenses and identification cards also have much of this information encoded in a magnetic stripe, bar code or both on the license or ID card.

Many customers do not want to carry their store cards with them but they still may want to charge the purchase to their store charge account. In these situations the sales clerk or cashier has to go into a manual process outlined by the store management to access the customer's store charge account and in many cases it is a time consuming process. If the customer wants to access their customer reward, VIP, or frequent shopper record, the manual process is usually not as time consuming.

Many businesses have significant losses due to stolen store charge cards. It is easy for a fraud artist to snatch a purse or wallet and use the store charge cards to make purchases or conduct other transactions using the various cards in the purse or wallet. The real customer is also affected in that he or she must prove that they did not perform the transaction.

### SUMMARY OF THE INVENTION

It is believed that there is a benefit in offering customers the option of using their drivers' licenses or state issued ID cards to access their records at various stores and businesses.

This invention is a methodology and system to access customers' store charge accounts and other records at various businesses by swiping a driver's license or state issued ID card with a magnetic stripe or bar code through a card reading device. By capturing certain information, namely driver's license or ID card number, that number is used to locate the customer's record on the store or business computer and open up the customer's record for activity. The driver's license or state ID card numbers of the customers would be linked to their record at each store or business offering this service. This could be accomplished via a cross reference file or incorporating the drivers' licenses and state issued ID card numbers in the customers' records on the store or business computer.

Most states in the US issue driver's license with either a magnetic stripe or a bar code that houses the driver's license number among various other data about the bearer. As referred to earlier, the driver's license can be swiped through a card reader device in order to capture the necessary number to access the bearer's store or business record. If the driver's license or state issued ID card doesn't have a magnetic stripe or bar code or if the magnetic stripe or bar code does not read when swiped through a card reading device, the driver's license or state issued ID card number can be entered manually by the sales clerk, cashier, business employee or perhaps the customer in order to access their store charge account or business record.

This invention offers convenience, security and added protection for customers as well as fraud prevention and efficiency for the stores or businesses offering this service. Further areas of applicability of this invention will become apparent from the detailed description provided hereinafter. It should be understood that the detailed description and specific examples, while indicating embodiments of this invention, are intended for purposes of illustration only and are not intended to limit the scope of the invention.

### BRIEF DESCRIPTION OF THE DRAWING

The present invention will become more fully understood from the detailed description and the accompanying drawing.

FIG. 1 is a schematic block diagram representatively illustrating the sequence of steps in accessing a store charge account or business record, specifically using a driver's license or state issued ID card. The access is by a cashier, sales clerk or other business employee at a transaction location, interacting with the store or business computer, and interacting with the customer.

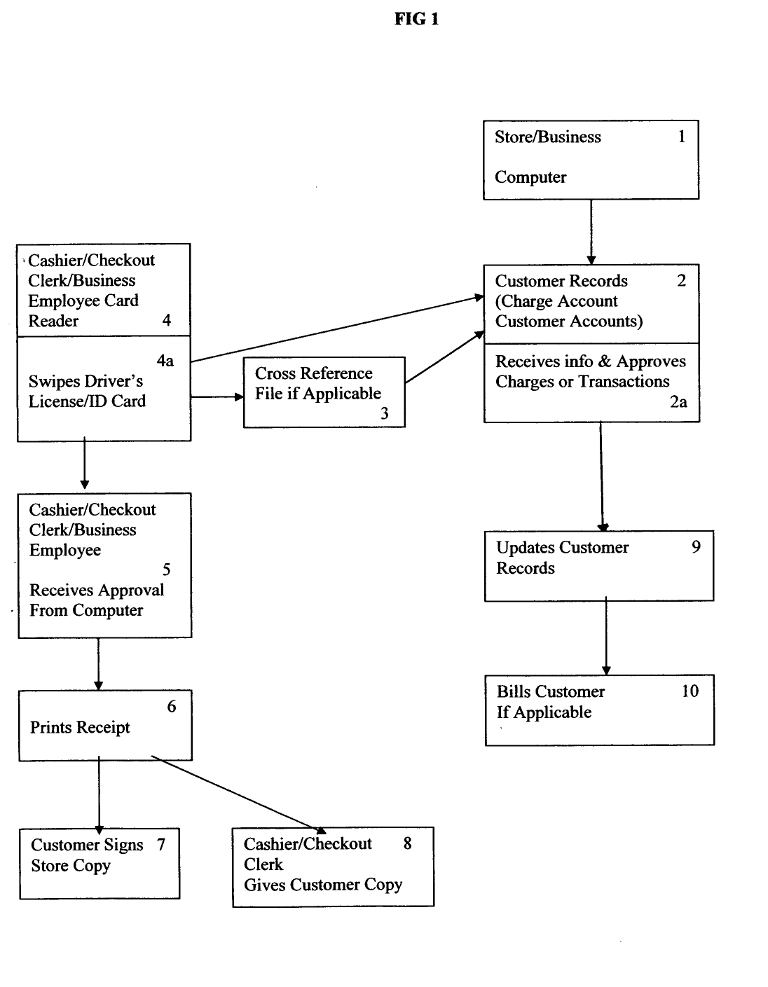

### DESCRIPTION OF EMBODIMENTS

The following description of the embodiment(s) of the present invention is merely exemplary in nature and is in no way intended to limit the invention, its application or uses. While the accompanying drawing and the following description thereof disclose the present invention in relation to embodiments thereof particularly adapted for use with driver's licenses and state issued ID cards, the system and methodology of the present invention is neither intended to be interpreted nor understood to be limited to applications or embodiments utilizing these limited forms of machine-readable media.

The present invention has a broad potential application and utility, which is contemplated to be adaptable to a wide range of stores and businesses and other forms of transactions in which customer information needs to be accessed on computers of said stores and businesses. For example, it is contemplated that accessing customers computer records via use of driver's licenses and state issued ID cards would be beneficial for use by any retail establishment offering store charge accounts for paying for goods or services, retail establishment offering reward cards, VIP cards, frequent shopper cards and discount cards. Additionally, it is contemplated that this system and methodology would be equally beneficial to be used for accessing customer records at movie rental stores, patient records at doctor offices, hospitals and other medical facilities. Fundamentally, therefore, it is to be understood that the present invention is contemplated to be applicable and usable by substantially any entity that maintains records of customers on their computer.

Referring now to the accompanying drawing, (box 1) represents the store or business computer where customer records are housed and need to be accessed in order to perform a transaction. For example, a retail store would house their customers' charge account records that allow their customers to purchase goods or services and pay for them by charging to the customer's store charge account. This same example would also apply to non-retail businesses where customers' records need to be accessed.

In the embodiment represented by (box 2) is the customers' records such as but not limited to store charge accounts and business records. These records are usually identified by a customer name and account number. The account number is normally developed by the business. However, many businesses may use customer's phone number, date of birth or social security numbers in addition to the customer's account number to access the customer's record on their computer. Customers' driver license numbers or state issued ID card numbers could be added to this record for purposes of accessing customers' records. In (box 2a) the store's computer receives information from card reader devices at the store, locates the appropriate customer record and acts upon the request. In the case of a purchase of goods or services, the store's computer would proceed to validate the request, update the customer's record and send an approval back to the sales clerk or cashier. In other uses the business computer would present the customer information to the business' employee entering the request via the card reader device.

If the store or business chose not to incorporate the customers' drivers' license numbers in their computer record, (box 3) represents a cross reference file housed on the store or business computer to accept a customer's drivers license number and convert it to the matching record number on the computer. The functions in (boxes 2 & 2a) would then be performed using this converted number.

The cashier, check out clerk or business employee represented by (box 4) would have access to a card reader device of some sort. It could be, but not limited to, a free standing card reader, card reader attached to computer terminal keyboard, bar code reader or any other device that can be used to scan information in a magnetic stripe or bar code field of information.

The customer, cashier, check out clerk or business employee would swipe the customer's drivers license through a card reader device as provided by the store or business as depicted in (box 4a). The driver's license number captured from the card reader device would be routed to the store or business computer to be processed according to the functions explained in (boxes 2 & 2a) above. If the store or business utilizes a cross reference file, the captured information from the step in (box 4a) would be routed through the cross reference application represented by (box 3).

If the transaction being performed by the customer is charging their store charge account for the payment of goods or services purchased, the cashier or check out clerk represented in (box 5) would receive, at their workstation, an approval from the store or business computer. For accessing other business records, the business computer would simply return information about the customer being serviced to the employee's workstation.

If the transaction being performed is charging a customer's store charge account for the purchase of goods or services, (box 6) represents the receipt printing function for the store. Two copies of the receipt are normally printed at this station for each transaction. If other business records are being accessed and a printed record of the transaction is needed, it would be printed in this step represented by (box 6).

In a transaction involving the accessing of customer's store charge account the customer would be asked to sign the receipt detailing the items purchased or service received (box 7). The store cashier or check out clerk would keep the signed copy since this receipt serves as the contract or agreement to pay for the goods purchased or services received. For accessing other business records, this receipt or document may simply be a notice of the transaction conducted and retained by the business. It may or may not be signed by the customer based on the business' procedure.

The cashier or check out clerk will give the customer (box 8) a copy of the receipt printed in (box 6) as evidence that the goods purchased or services rendered were paid for by charging the customer's store charge account. The customer copy of the receipt serves as evidence that the customer paid for the goods or services. It also provides information the customer can use to update their records or verify transaction when they receive a statement.

All transactions whether for accessing store charge accounts or other business records are updated on the store or business computer represented in (box 9).

At the appropriate time the customer will be billed (box 10) for items charged to their store charge account. This serves as notice that items have been charged to their account as well as notice to make payment as appropriate. If the transaction represents access to a business account, a notice may or may not be sent to the customer.

What is claimed is:

1. A methodology for accessing customers' charge accounts at retail stores and accounts at other businesses using a state issued driver's license or state issued identification card (ID card) comprising the steps of:
(a) obtaining information from the person sufficient to confirm the person's identity;
(b) creating a record of portions of identifying information for that person;
(c) issuing a driver's license or state ID card, including
(1) recording information on the driver's license or state issued ID card that is human readable; and
(2) encoding certain portions of identification information in a machine readable format using for example, magnetic stripe, bar code, computer chip;
(d) assigning a unique personal driver's license or ID card number;
(e) recording the unique number on the driver's license or ID card in both human readable as well as machine readable format.

2. A methodology for using the unique personal driver's license or state issued ID card according to claim 1, to access a customer's store charge account or business record.

3. A methodology for using the driver's license or state issued ID card according to claim 1, to swipe through a card reader designed to read magnetic information recorded on the driver's license or state issued ID card.

4. A methodology for using the driver's license or state issued ID card according to claim 1, to scan with a bar code scanner designed to read bar code information recorded on the driver's license or state issued ID card.

5. A methodology for using the driver's license or state issued ID card according to claim 1, to read in a smart card reader designed to read information recorded in a computer chip recorded on the driver's license or state issued ID card.

6. A methodology for using the driver's license or state issued ID card according to claim 1, to manually enter the personal unique driver's license or state issued ID card number through a computer keyboard or key pad designed for entering information for processing on the store or business computer.

7. A methodology for retail stores to establish charge accounts for customers who wish to purchase goods or services and pay for them over time by the following:
a. obtaining personal information of a customer so as to identify that customer;
b. determine the credit worthiness of the customer;
c. open a record on the store computer for each customer by;
(1) entering the name and address for the customer opening a store charge account
(2) entering credit limits for each customer
(3) assigning a unique store account number for each customer
(3) assigning other unique identifying numbers or information used to access the customer's account.
(4) assigning the customer's driver's license number or state issued ID card number to the store charge account to be used to access the record.

8. A methodology for accessing a customer's store charge account according to claims 1 and 7 by having a customer swipe their driver's license or state issued ID card through a card reader to access their account.

9. A methodology for accessing a customer's store charge account according to claims 1 and 7 by scanning the customer's driver's license or state issued ID card using a bar code scanner to access the customer's account.

10. A methodology for accessing a customer's store charge account according to claims 1 and 7 by the cashier or check out sales clerk entering the customer's driver's license number or state issued ID card number into the store computer via the computer keyboard or separate keypad.

11. A methodology for accessing a customer's store charge account according to claims 1 and 7 using customers' drivers licenses and state issued ID cards in addition to using the store issued charge cards.

12. A methodology for any business to establish a unique customer records to validate, record and track transactions performed by their customers by the following:
a obtaining personal information from the customer in order to establish a unique record for that customer;
b. obtain from the customer or assign a unique number by which the customer record can be accessed;
c. establish a record using a unique access card given to the customer containing a magnetic stripe or bar code having that same number.

13. A methodology for accessing a customer's record at a business according to claims 1 and 12 using their driver's license or state issued ID card by having the customer swipe their driver's license through a card reader to access their business account record.

14. A methodology for accessing a customer's record at a business according to claims 1 and 12 by the business employee scanning the customer's driver's license or state issued ID card through a bar code scanner to access their business record.

15. A methodology for accessing a customer's record at a business according to claims 1 and 12 using the business' computer keyboard or numeric keypad to enter the customer's driver's license or state issued ID card number.

16. A methodology for accessing a customer's record at a business according to claims 1 and 12 using the customer's driver's license or state issued ID card in addition to the business issued access card.

17. A methodology for accessing customers' records at retail stores and other businesses according to claims 1, 7 and 12 presents the employees of these stores and businesses a greater opportunity to prevent fraud by using an access vehicle like drivers' licenses and state issued ID cards. The driver's license and state issued ID cards offer the same machine readable features as most store charge cards and business access cards but the driver's license and state issued ID card offer much more human readable information available to the store cashier or check out clerk or business employee than is available on other forms of store charge cards or business access cards.

18. A methodology for accessing customers' records at retail stores and other businesses according to claims 1, 7 and 12 by using a cross reference file of drivers' license numbers and state issued ID cards to customers' account numbers assigned by the store or other business where the drivers' license numbers and state issued ID card numbers are not incorporated in the customer record at the store or business.
